(19) United States
(12) Patent Application Publication
(10) Pub. No.: US 2018/0096268 A1
(43) Pub. Date: Apr. 5, 2018

(54) METHOD OF REDUCING OPERATIONAL COSTS

(71) Applicant: Chris Schumaker, Akron, OH (US)

(72) Inventor: Chris Schumaker, Akron, OH (US)

(21) Appl. No.: 15/681,399

(22) Filed: Aug. 20, 2017

Related U.S. Application Data
(60) Provisional application No. 62/402,265, filed on Sep. 30, 2016.

(51) Int. Cl. G06Q 10/06

(52) U.S. Cl. CPC G06Q 10/067

(57) ABSTRACT

A method of reducing the operational costs associated with a business practice. The general structure of any business may be illustrated by a sine wave. The negative valleys and positive peaks of the wave are capable of relating to the costs and benefits, respectively, of any business practice. The significance of the wave is that once a reference baseline has been established, all costs associated therewith are an independent function of the frequency of the wave: while the magnitude of the peaks and valleys may change as a result of the size of the business, the frequency will remain constant. Those economic factors which result in the raising or lowering of the baseline are therefore responsible for the lengthening and shortening of the frequency of the wave. The present invention relates to a method of restoring the balance to the wave such that the baseline is returned to the original state through the reducing of operational costs, therefore preserving the profit margins which were associated with the business prior to the shifting of the baseline.

### TECHNICAL FIELD

A method of reducing the operational costs associated with any business practice. More specifically, a method of maximizing the profits resulting from a particular industry by way of minimizing the operational costs associated therewith. The proposed method is applicable to all types of businesses and industries, regardless of the goods which are produced or the services which are offered.

### BACKGROUND

All industries, regardless of the goods or services with which they are associated, operate along a similar business structure, or economic “blueprint”. A visual representation of this economic “blueprint” may best be represented by a sine wave. The frequency of a sine wave may be used to accurately trace the continuous flow of a business; no industry, regardless of the amount of success or failure, may be depicted in a linear fashion. Each of the peaks and valleys of a continuous wave relate to the positives and negatives associated with a particular business.

A crucial aspect when viewing the peaks of a sine wave is to determine the baseline of the wave. The baseline, or reference point at which the wave transitions from positive to negative values, as well as from negative back to positive values, is critical to the success of a business. Once a baseline has been established, the opposing peaks of the wave may be portioned off into distinct categories, or sectors, of generalized business operations.

The positive peaks of the wave represent three general aspects of any business model: people, equipment, and profit. When referring to people, every industry requires at least some level of human employment. Whether this takes the form of physical labor, human design, or the rendering of services, human participation remains a critical function of any business. The second sector of the positive peak of a wave accounts for equipment. This may take the form of equipment in a classical sense, such as computers or machinery which are critical to the operation of a particular business. However, this may also include such equipment as utensils which play a role in performing intermediate steps of an operation. The third sector, and crown portion of the positive peak, is illustrative of the profits which result from a particular business.

The negative portion of the wave, often times referred to as a valley, may also be demonstrated by a segmented illustration which involves three unique sectors. The three sectors of the negative valley considerably reflect that of the corresponding sectors of the positive peak. The first sector is made up of the wages which must be distributed to employees. All human labor brings about the payment of related compensation to that of the work being performed. The second sector is concerned with the operational costs of a particular business. In order to both sustain and maintain the operation of equipment, a monetary cost is associated therewith. Such costs may include, but are not limited to, the day to day costs of operating such equipment as well as the maintenance costs of repairing equipment. The third and final sector of the negative valley is composed of losses. The losses of a business are a direct corollary to that of the profits; whenever success is being achieved, there will also be associated failures.

The magnitude of the peaks and valleys of a particular wave are determined by the size of the company. As a business model becomes larger and larger, the resultant peaks of the related sine wave begin to grow. Conversely, as a business begins to shrink, the corresponding sine wave will exhibit shorter peaks and valleys. Therefore, while the magnitude of the corresponding peaks and valleys may change, the frequency of the wave will remain constant. Any change which causes the wave to exhibit taller peaks will correspondingly result in the lengthening of the converse valleys. The same behavior is exhibited when addressing the shortening of the peaks and valleys.

The frequency of the wave may be viewed as a dependent variable, with the function which the wave is primarily dependent upon being the economy. As economic factors within the economy change, the baseline which was predetermined for a particular business begins to shift. As the baseline shifts (either upward or downward), the frequency of the sine wave is thrown out of balance as the magnitude of both the peaks and valleys are no longer changing in harmony with one another.

For example, if an economic factor causes the wages of all employees to be uniformly increased, then the baseline will be raised. However, as the number of employees required to perform the necessary duties of the job has not decreased in comparison to this change, the costs of the associated wages will be higher. As the baseline of the wave is raised, the sectors associated with both people and equipment must therefore be restructured so that they contain the same area as before the raising of the baseline. Therefore, the sector which is ultimately reduced by the raising of the baseline is the size of the profits. This asymmetrical shift in the size of the peaks and valleys of the wave must therefore be addressed through other means.

The most common response from a business, when confronted with a baseline which moves upward resulting in reduced profits, is to increase the price of the goods or services which they offer. This unilateral increase in price is able to counteract the initial problem which resulted in the raising of the baseline, therefore causing the line to return to its initial value. As this process continues over numerous cycles, the result is an economy which continues to inflate. As the price of goods and services continue to rise based upon artificial factors which are subjectively injected into the economy, businesses will continually have their hands forced into perpetuating this vicious cycle.

The present invention aims to address the issues referenced above. By allowing businesses to lower, or “reset”, the baseline of the sine wave associated with their particular practice or industry, the economy as a whole will benefit through goods and services which remain at more consistent prices. The reduction of operational costs may act to lower the baseline of the wave in proportion to that of the factors which caused the wave to be initially raised, therefore exhibiting a sine wave of restored frequency.

### SUMMARY

The general practice of a business may be represented by that of a sine wave. The magnitude of the peaks and valleys of the wave are dependent only upon the size of the business which is at issue. The frequency of each wave remains constant in the absence of economic factors. When economic factors are introduced, those which are beyond the control of the business owner, the baseline of the sine wave is shifted either up or down, thus altering the frequency of the related sine wave.

The present invention provides for a method of adjusting the operational characteristics of a business such that the associated changes are able to offset the economic factors which resulted in a raising of the baseline of the sine wave. The method of the present invention allows for businesses to retain their current profit margins when faced with adverse conditions which cause the baseline of the sine wave to be raised. The identification of common characteristics between businesses of differing scope allows for the method of the present invention to retain a wide range of applicability.

### BRIEF DESCRIPTION OF THE DRAWINGS

The accompanying drawings in the following description illustrate various embodiments of the present disclosure.

FIG. 1 is an embodiment of the sine curve which illustrates the general structure which is illustrative of all business practices.

FIG. 2 is a further embodiment of the sine curve illustrating the general structure of business practices in which the baseline has been raised upward.

FIG. 3 is a further embodiment of the sine curve illustrating the general structure of businesses practices in which the baseline has been raised upward and the area of the profit sectored has been decreased.

FIG. 4 depicts the average price of different octane gasoline on a specific date in time.

### DETAILED DESCRIPTION

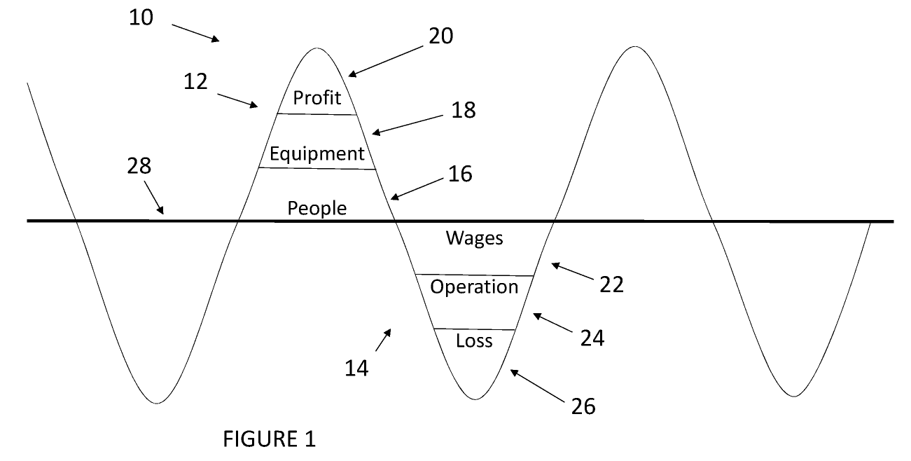

With reference to FIG. 1, a sine wave 10 is shown which relates to the general structure of any business. The sine wave 10 is composed of two distinct portions: the positive peaks 12 and the negative valleys 14. Each of these curves may further be broken down into three distinct sectors.

With continued reference to FIG. 1, the first sector of the positive peak 12 is comprised of people 16. People 16 may encompass any level of human employment which is necessary to the functioning of a business. This may include employee's engaged in physical labor, intellectuals, researchers, writers, those involved in customer interaction; any individual which is associated with a business is thought to be included within the sector designated as people 16. The second sector of the positive peak 12 is comprised of equipment 18. The scope of equipment 18 is to encompass any physical equipment which is a part of a business's operation. The third sector is comprised of profits 20. With regard to the negative valley 14, the first sector is comprised of wages 22. Wages 22 will include any payment to those individuals which have been prescribed to fall into the category of people 16. The second sector is comprised of operations 24. Operations 24 is to be broad enough so as to encompass such things as day to day operational costs, maintenance costs, raw material costs, and any other costs which may be associated with the ongoing operation of a business. The third and final sector of the negative valley 14 is comprised of losses 26.

With continued reference to FIG. 1, what determines the point at which the sine wave 10 crosses between the positive and negative values is the baseline 28. In theory, the baseline 28 is set according to the economic factors which dictate a business model at the time of conception. However, the baseline 28 of any business model is not stagnant. Rather, the baseline 28 will be forever fluctuating based upon the economic factors which effect a given industry.

According to one embodiment, an economic factor has a direct impact on the sine wave 10. A direct impact is an economic factor which causes a direct rise or fall of one of the sectors of the sine wave 10. By way of one example, an economic factor of direct impact would be the raising of the minimum wage which an employer is required to pay his or her employees. By way of another example, an economic factor of direct impact would be the raising of the cost of a commonly used substance which is necessary for daily business operations. Such substances may include, but are not limited to, water or any type of cleaning fluids, raw materials, or any intermediary products. According to this embodiment, the economic factor having a direct impact will result in the baseline 28 of the sine wave 10 being raised upward. The economic factor of direct impact would cause the size of one of the sectors of the negative valley 14 to increase, thereby shifting the baseline 28 in an upward direction.

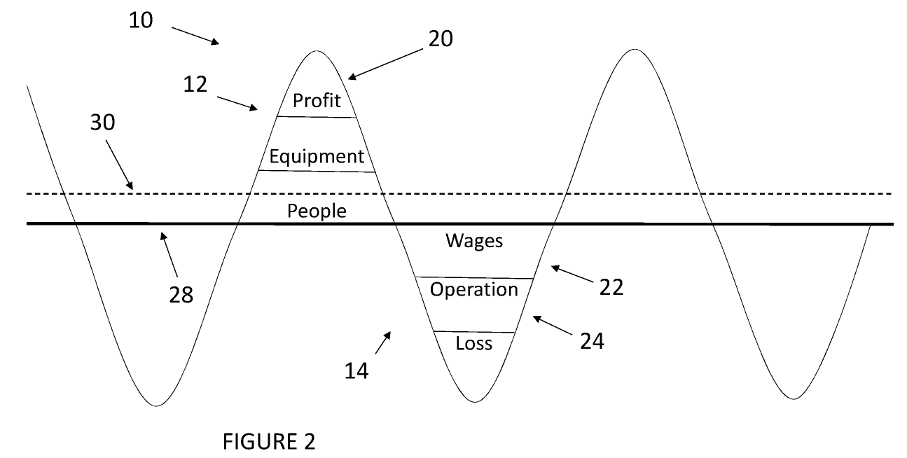

With reference to FIG. 2, the new baseline 30 is shown with reference to the original baseline 28. The new baseline 30 causes the frequency of the sine wave 10 to change as the magnitude of the peaks and valleys of the wave are no longer reflective of one another. In order for parity to be restored to the sine wave 10, the sectors of the positive peak 12 are often times adjusted. The most common adjustment is for the profits 20 to experience the bulk of the adjustment, thereby being decreased.

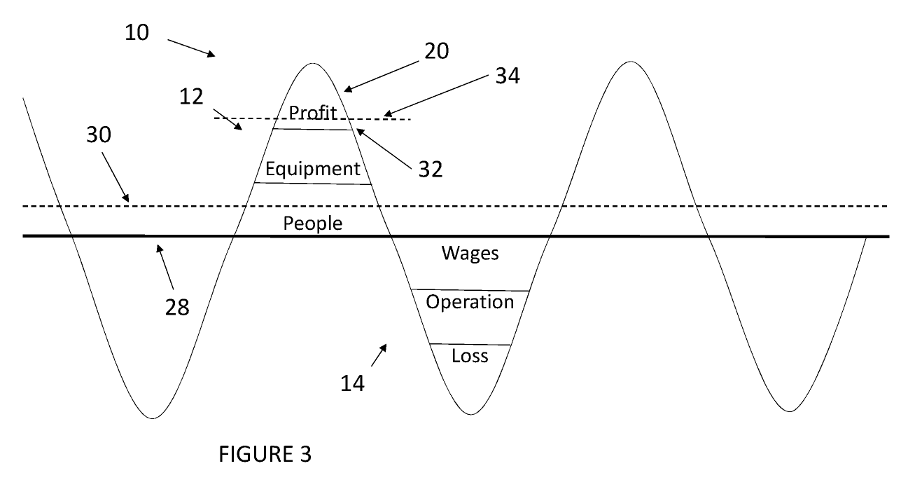

With reference now to FIG. 3, a sine wave 10 is shown in which the new baseline 30 has been raised upward with reference to the original baseline 28. In order to account for this rise in negative valley 14 costs, the area of the profits 20 located within the positive peak 12 have been reduced by way of shifting the line 32 which defines the profit sector upward such that a new line 34 is present at a position which is closer to the crown of the positive peak 12.

Returning now to FIG. 2, however, the present invention proposes a method for allowing the positive peaks to remain unaltered, or virtually unaltered, by way of adjusting the sectors of the negative valleys 14 in such a manner so as to offset the changes brought on by the economic factor of direct impact.

According to one embodiment, when the economic factor of direct impact effects the sector of wages 22 of the negative valley 14, the sector of operational costs 24 are adjusted such that the new baseline 30 returns to the previous level of the old baseline 28. Alternatively, when the economic factor of direct impact effects the sector of operational costs 24 of a business, the new baseline 30 may be restored to its original level by thereby adjusting the sector of operational costs 24. Any increase in the negative valley 14 which causes the original baseline 28 to rise may be accounted for by a shift of relative magnitude of at least one of the sectors of the negative valley 14.

According to one embodiment, all of the costs associated with operation (those costs which collectively make up the sector of operational costs 24) are viewed independently of one another. The costs may then be grouped by any number of identifying factors, such as relation to one another, effect on profits, number of job personnel required for operation, or any other objective indicia of significance chosen by the party reviewing the costs. The independent costs may be grouped any number of times as is needed to further understand the interaction between all of the different operational costs. After sufficient review, those independent operational costs which are of the greatest significance to the reviewing party are chosen for further review. The term reviewing party, as used throughout the present disclosure, is to refer to that party which is responsible for the reviewing of the gathered data and thus in control of determining the method of the present invention. The reviewing party may be a single person, a panel of designated individuals, a team of individuals, or any other combination of living persons which is capable of evaluating information, either independently or collectively, and reaching a conclusion. The term greatest significance may be defined by the reviewing party by such factors as impact on the overall profits, usefulness to society, commonality to the public, or any other number of factors which the reviewing party seeks to attempt to optimize. The analysis of independent operational costs will thus result in the reviewing party having the ability to further refine their business practices around those operational costs which have been identified as being of the greatest significance. A more streamlined approach and allocation of resources with respect to such operational costs will thus result in an overall decrease in the sector of operational costs 24, thereby allowing the new baseline 30 to return to its original position 28 without thereby effecting the area of the profits sector 20.

According to one embodiment, the review of operational costs is done by analyzing all of the necessary information and allowing the reviewing party a great deal of discretion in analyzing the information. This may allow for the reviewing party to input their subjective viewpoint into the analysis of operational costs such that the method of reducing such costs is more reflective of an ever changing market.

According to another embodiment, a computer or computer-assisted or computer-like system is used so as to compile all of the information related to operational or other costs. The computer or other related system may be used to organize the collected data according to the desires of the reviewing party. By way of one example, the reviewing party may implement organizational software. By way of another example, the reviewing party may utilize a number processing program which is capable of performing mathematical functions and other like processes. According to a further embodiment, a computer or other related device may be used to map the business practices about a sinusoidal wave. The computer or other related device may be useful for purposes of manipulating the parameters of the wave according to the objective indicia of significance which have been identified for a particular business. By way of one example, computer software may be used to evaluate the costs and benefits according to particular objective indicia of significance, at the discretion of the reviewing party.

According to another aspect of the present invention, the reviewing party may determine a pre-selected action to be undertaken in alteration of business practice depending upon a predicted change in the objective indicia of significance which have been identified for a particular business. Such a pre-selected action, or series of actions, can then be input into the computer or other system such that when the right conditions are present, the computer or other system automatically adjusts the appropriate business practice to reduce costs according to the predetermined objective, thereby automating the disclosed method. By way of one example, the reviewing party may predetermine that in the event of an increase in a particular one of the sectors of the negative valley 14, the desired adjustment is to the operational costs 24. This would then be input into the computer or other system, and if the pre-selected event occurs, the computer or other system would automatically make the desired adjustment to the sector of operational cost 24 without further involvement from the reviewing party.

By way of one example, a gas station is chosen as the relevant business and a raise in the minimum wage which must be paid to the employees thereof is chosen as the economic factor of direct impact. This increase in wages will cause the original baseline 28 to be raised to a new level, baseline 30. In order to address this raising to a new baseline 30, a reviewing party is chosen to evaluate the operational costs 24 of the business. After analyzing all of the operational costs both independently and grouped into various categories based upon specified indicia of importance, the reviewing party will come to a conclusion regarding the operational costs. One such conclusion which may be reached is that the price of transporting gasoline from a refinery or other distribution location is too high. In order to address this problem, the reviewing party may begin to formulate ideas of how to decrease these costs. One such idea may be for the gas station to focus their services on the sale of just 87 octane gasoline. The objective indicia which may prompt such a decision may include the lower sales cost of 87 octane or the higher market demand for individuals purchasing 87 octane. However, the objective indicia may also promote such a change by showing that the operational costs of stocking both 89 and 93 octane gasoline, respectively, are too high. This may be the result of decreasing the number of trucks or trips needed to stock only one type of gasoline, while also decreasing the cost of raw materials as the purchase cost of 87 octane is lower than that of either 89 or 93 octane, respectively.

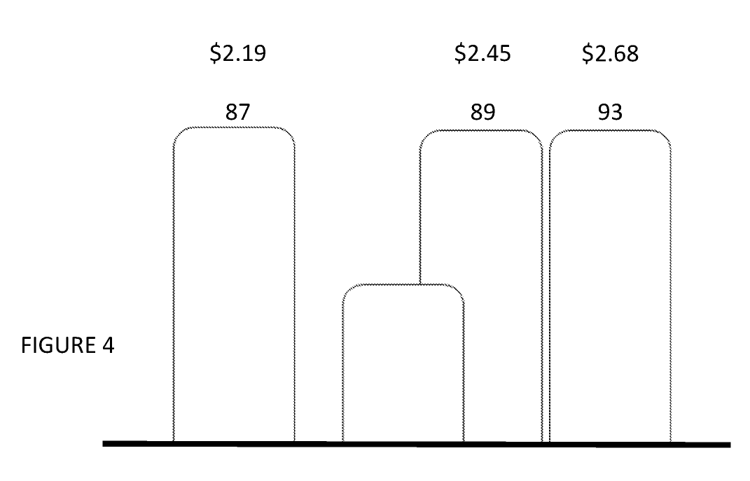

With reference to FIG. 4, the price of different octane gasoline is shown at a particular point in time (Aug. 25, 2016) so as to further illustrate the example previously provided. As can be seen from FIG. 4, the price at the pump of 87 octane gasoline is significantly less than that of either 89 octane or 93 octane, respectively.

According to another embodiment, the economic factor which effects the baseline of the sine wave may do so in an indirect manner. As opposed to that of an economic factor of direct impact, an economic factor of indirect impact is one which has an ultimate effect on one of the sectors of the sine wave but which is achieved through ancillary or peripheral means. By way of one example, an economic factor of indirect impact may be one which is responsible for the raising of prices of raw materials needed for a particular business. While the factors which effect the raw material prices would be seen as a direct impact to that business which is concerned with the process of producing those raw materials, those same economic factors would be seen as having an indirect impact on a business which then purchases those raw materials. Often times an economic factor of indirect impact is one which is an economic factor of direct impact which has been further removed from the party which is directly impacted. However, this need not always be the case. For the purposes of the present invention, economic factors of indirect impact are to be treated as having the same end result as those of economic factors of direct impact. Therefore, all embodiments of the present invention exhibit reciprocity with one another in terms of the economic factors in which they are able to address; any embodiment of the present invention which is applicable for purposes of addressing an economic factor of one type of impact (direct or indirect) is therefore also applicable for purposes of addressing an economic factor of the other type of impact (direct or indirect).

According to one embodiment, the objective indicia used to determine which operational factors are to be addressed by the reviewing party are chosen according to their commonality to the public at large. By way of one example, a determining factor for purposes of significance may be the number of individuals that consume a particular product. By way of another example, a determining factor may be the number of individuals which are exposed to a particular compound or component.

According to another embodiment, after the reviewing party has determined the operational costs which are of the greatest significance, the decision resulting therefrom may be to restructure or reorganize particular elements of the business. By way of one example, the business may take a more targeted, or “streamlined”, approach to a particular area of focus. This may manifest itself by retracting some of the more far reaching expanses of the business in order to reallocate certain resources in a more efficient manner towards those assets which are seen to have more success or lower related operational costs. By way of another example, the business may take a more expansive approach. This may include the literal expansion of the size of the business, expanding the breadth of coverage or industries in which the business is involved, or any other decisions of a similar scope.

As described above, the present disclosure has been described with preferred embodiments thereof and it is understood that many changes and modifications to the described embodiments can be carried out without departing from the scope and the spirit of the present disclosure that is intended to be limited only by the appended claims.

Having thus described the invention, it is now claimed:

I claim:

1. A method of reducing the costs associated with a particular business, comprising:
establishing a reviewing party, said reviewing party being responsible for the carrying out of all subsequent steps of the current method;
plotting the associated costs of a business about a sinusoidal wave;
establishing a baseline for said sinusoidal wave, said baseline separating the sinusoidal wave such that the positive peaks and negative valleys are symmetrical to one another;
separating the positive peak of said sinusoidal wave into three sectors, the three sectors comprising:
people;
equipment, and;
profit;
separating the negative valley of said sinusoidal wave into three sectors, the three sectors comprising:
wages;
operation, and;
loss;
identifying an economic factor which causes said baseline to shift;
analyzing the information which comprises one of the sectors of the negative valley so as to formulate patterns and conclusions regarding said information according to objective indicia of significance;
identifying those costs within the designated sector which will be addressed, and;
altering at least one business practice such that said costs within the designated sector are reduced so as to reduce the overall cost of said sector,
wherein the sectors of each of the positive peaks and negative valleys consist of individual costs associated with their respective sectors.

2. The method of claim 1, wherein the economic factor responsible for the shift of the baseline is a direct economic factor.

3. The method of claim 1, wherein the economic factor responsible for the shift of the baseline is an indirect economic factor.

4. The method of claim 1, wherein a computer or computer-like system is used by the reviewing party for the purposes of carrying out the method.

5. The method of claim 4 wherein the computer or computer-like system is prepopulated with a condition or series of conditions whereby the computer or computer-like system can automatically perform the step of altering at least one business practice according to the presence of the predetermined condition or series of conditions.

6. The method of claim 1, wherein the objective indicia of significance carrying the greatest weight is that of the commonality of the operation to the public at large.

7. The method of claim 1, wherein the economic factor causes the baseline to shift upward.

8. The method of claim 1, wherein the economic factor causes the baseline to shift downward.

9. The method of claim 1, wherein the reviewing party is a single individual.

10. The method of claim 1, wherein the reviewing party consists of at least two individuals.

11. The method of claim 1, wherein the baseline is restored to the initial position upon the altering of the costs within a designated sector.

12. The method of claim 1, wherein the sector to be manipulated is the operation sector.

13. The method of claim 1, wherein the associated business is a gas station.

14. The method of claim 13, wherein the identifying economic factor which causes the baseline to shift is the raising of the minimum wage of the employees of said gas station.

15. The method of claim 14, wherein the objective indicia of significance are the differing costs associated with 87, 89, and 93 octane gasoline.

16. The method of claim 15, wherein the alterations to the business practice is by way of only producing 87 octane gasoline.

17. The method of claim 15, wherein the alterations to the business practice is by way of only stocking 87 octane gasoline.

18. The method of claim 15, wherein the alterations to the business practice is by way of only transporting 87 octane gasoline.
